(19) United States
(12) Patent Application Publication
(10) Pub. No.: US 2021/0288453 A1
(43) Pub. Date: Sep. 16, 2021

(54) CONNECTOR

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventors: Yuya Tsukamoto, Yokkaichi, Mie (JP); Akihiro Hayashi, Yokkaichi, Mie (JP); Noriyuki Uematu, Yokkaichi, Mie (JP)

(21) Appl. No.: 16/607,792

(22) PCT Filed: Apr. 12, 2018
(86) PCT No.: PCT/JP2018/015316

§ 371 Date: Oct. 24, 2019

(30) Foreign Application Priority Data
Apr. 26, 2017 (JP) 2017-087166

(51) Int. Cl. H01R 13/703

(52) U.S. Cl. CPC H01R 13/7031; H01R 13/5205; H01R 2201/26

(57) ABSTRACT

A service plug (1) is provided with a female connector housing (20) including a plurality of female terminals (30), and a male plug (10) detachably mountable into the female connector housing (20) along an insertion direction. The male plug (10) includes one male terminal (11) that is long in the insertion direction. Each female terminal (30) includes a female body (31) dimensioned to receive the male terminal (11) therein. The female bodies (31) are aligned coaxially with the inserting direction. The one male terminal (11) is inserted into the coaxially aligned female bodies (31) so that the female terminals (30) and the one male terminal (11) are connected electrically by mounting the male plug (10) into the female connector housing (20).

### BACKGROUND

### Field of the Invention

This specification relates to a service plug.

### Related Art

The high-voltage circuit that is used to drive a motor of a hybrid vehicle or an electric vehicle must be shut off at the time of inspection/maintenance. Generally, a service plug is provided for this purpose.

Japanese Unexamined Patent Publication No. H10-144429 discloses such a service plug. This service plug includes a circuit container and a detachable plug detachably mountable into the circuit container.

The detachable plug includes a rectangular lever, a plug body formed of a metal conductor coupled to the lever and two male terminals projecting from the plug body. The male terminals are in the form of bars and are electrically conductive via the plug body.

The circuit container includes two female terminals at positions corresponding to the two male terminals of the detachable plug when the detachable plug is mounted into the circuit container. The female terminals are fit to the male terminals of the detachable plug. The female terminal includes a tubular body into which the male terminal is inserted, and a wire connecting portion provided behind the body. A high-voltage wire is connected to the wire connecting portion of each female terminal, one side of the high-voltage wire is connected to a high-voltage power supply and the other side is connected to a device side.

Normally, the detachable plug is mounted in the circuit container. The two male terminals of the detachable plug are inserted into the bodies of the respective female terminals of the circuit container and the respective male terminals and female terminals are electrically conductive. In this way, the two female terminals connected to the high-voltage wires are short-circuited through the respective male terminals and the plug body. On the other hand, at the time of inspection/maintenance, the detachable plug is pulled out to shut off the high-voltage circuit.

However, in the conventional service plug, the detachable plug is provided with two male terminals for two female terminals provided in the circuit container and it has been necessary to provide the plug body linking the male terminals. Thus, it has been difficult to reduce the size of the service plug.

### SUMMARY

A service plug disclosed in this specification has a female connector housing including female terminals, and a male plug detachably mountable into the female connector housing. The male plug includes a male terminal that is long in a vertical direction. Each female terminal includes a female body, and the male terminal is insertable into the female body. A plurality of the female bodies are arranged coaxially with respect to an inserting direction of the male terminal inside the female connector housing, and one male terminal is inserted into the female bodies so that the female terminals and the one male terminal are connected electrically by mounting the male plug into the female connector housing.

In a conventional service plug, it has been necessary to provide a male plug with as many male terminals as female terminals, and a metal conductor linking the male terminals has been necessary. However, in the subject invention, the female terminals in the female connector housing simultaneously are connected electrically by one male terminal provided in the male plug. This eliminates the need for the conventionally required metal conductor linking the male terminals and requires only one male terminal. Thus, the male plug can be reduced in size. Further, in the conventional service plug, it has been necessary to provide as many cavities as female bodies in a female connector housing. However, in the subject invention, the female bodies are disposed coaxially with respect to the inserting direction of the male terminal into the female connector housing. Thus, one cavity in the female connector housing can be used in common, and the female connector housing and the entire service plug can be reduced in size. Further, as the service plug is reduced in size, the cost of the service plug can be reduced.

Further, the metal conductor that links the male terminals in the conventional male plug is unnecessary and the number of the male terminals conventionally required to be as many as the female terminals is reduced to one. Thus, the used amount of the conductor of the male plug is reduced. In this way, the resistance of the conductor portion of the male plug can be reduced.

The male plug may include a circular annular grip, and the grip may be provided on an upper end part of the male terminal.

Since the metal conductor required in the conventional male plug is unnecessary, as described above, the male plug can be reduced in size. Further, a hand-grippable grip conventionally has been necessary. However, since one male terminal is used according to the above configuration, the grip of the male plug can be formed into a circular annular shape that can receive an index finger. The male plug can be reduced in size also by this.

The female terminal may include a wire connecting portion extending in a direction intersecting the inserting direction of the male terminal from an end part of the female body. Thus, wires are not disposed on an insertion path for the male terminal, and damage of the wires by the male terminal can be prevented.

Accordingly, to the service plug disclosed in this specification can be reduced in size.

### BRIEF DESCRIPTION OF THE DRAWING

FIG. 1 is a section of a service plug before a male plug is mounted.

FIG. 2 is a section of the service plug after the male plug is mounted.

### DETAILED DESCRIPTION

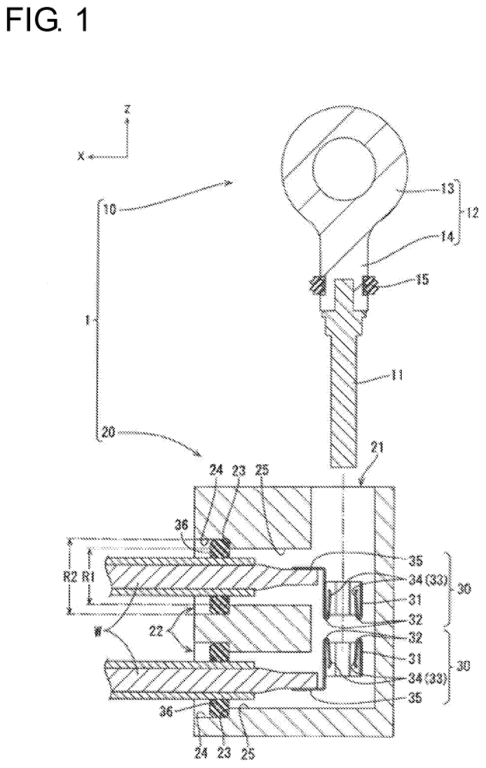

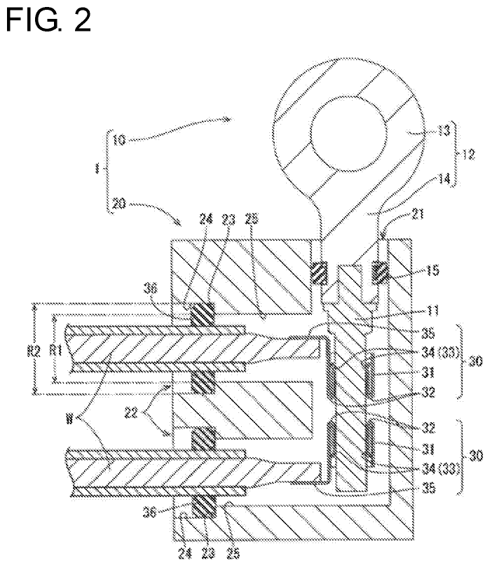

An embodiment is described with reference to FIGS. 1 and 2.

A service plug 1 of this embodiment includes a female connector housing 20 and a male plug 10 detachably mountable into the female connector housing 20. In the following description, a Z direction and an X direction in FIG. 1 are referred to as an upward direction and a forward direction.

The male plug 10 includes a male terminal 11 and a grip 12 provided on an upper part of the male terminal 11. The male terminal 11 is in the form of a bar long in a vertical direction, and is formed by cutting a bar material made of metal. The grip 12 is formed of resin and includes a circular annular grip body 13 and a grip base 14 provided below the grip body 13. The grip body 13 has a circular annular shape and the size of a hole is so set that an index finger is, for example, insertable. A hole, into which the male terminal 11 is press-fit, is provided in the lower end surface of the grip base 14. An upper part of the male terminal 11 is press-fit into the hole in the lower end surface of the grip base 14, and the male terminal 11 is fixed to the grip base 14. Since the male plug 10 is composed of one male terminal 11 and the grip 12 provided with such a hole that an index finger is, for example, insertable therein, the male plug 10 can be reduced in size as compared to a conventional configuration composed of two male terminals, a metal conductor linking the two male terminals and a grip portion of a hand-grippable size.

The female connector housing 20 is formed of resin and has a rectangular shape. The female connector housing 20 includes a first cavity 21 into which the male terminal 11 is inserted, and two second cavities 22 into which wires W to be described later are inserted

The first cavity 21 is open in the upper surface of the female connector housing 20 and has a space in the form of a circular hole into which the male terminal 11 is insertable from above the female connector housing 20. An inner diameter of the first cavity 21 is somewhat smaller than an outer diameter of a rubber ring 15 fit on the grip base end part 14.

Two second cavities 22 are provided one above the other in the vertical direction, and each second cavity 22 is open in the front surface of the female connector housing 20. Each second cavity 22 includes a space in the form of a circular hole into which the wire W to be described later is insertable from the front of the female connector housing 20. The rear end of each second cavity 22 is open, and the internal space of each second cavity 22 communicates with the first cavity 21. Each second cavity 22 is composed of a front part 24 and a rear part 25, and the front part 24 and the rear part 25 are connected via a step 23. An inner diameter R1 of the front part 24 of the second cavity 22 is somewhat smaller than an inner diameter of a rubber ring 36 to be described later. Further, an inner diameter R2 of the rear part 25 of the second cavity 22 is smaller than the inner diameter R1 of the front part 24. The rubber ring 36 is mounted on the wire W to be described later and comes into contact with the step 23 from the front.

Each female terminal 30 is formed by press-working and bending a metal plate. Two female terminals 30 are disposed side by side in the vertical direction inside the first cavity 21. The upper female terminal 30 includes a box-shaped female body 31 open in the vertical direction and a plate-like wire connecting portion 35 extending forward from an upper part of a front wall of the female body 31. Resilient contact pieces 33 are provided inside the female body 31 extend up from lower end parts of both side walls of the female body 31 via contact piece base end parts 32. Contact portions 34 are provided on tip parts of the resilient contact pieces 33 and are embossed to project toward centers of the side walls of the female body 31. The respective resilient contact pieces 33 resiliently contact the male terminal 11 via the contact portions 34 when the male terminal 11 is inserted into the female body 31.

The wire W inserted into the front part 24 of the upper second cavity 22 of the female connector housing 20 is connected to the wire connecting portion 35 of the upper female terminal 30. An outer diameter of the wire W is somewhat larger than an inner diameter of the rubber ring 36. Further, since the outer diameter of the rubber ring 36 is somewhat larger than the inner diameter R1 of the front part 24 of the second cavity 22, as described above, the rubber ring 36 functions to seal the second cavity 22. The other end of the upper wire W is connected to a high-voltage power supply, although not shown.

The lower female terminal 30 is disposed inside the first cavity 21 in a posture vertically inverted from that of the upper female terminal 30. Further, the wire W inserted into the front part 24 of the lower second cavity 22 is connected to the wire connecting portion 35 of the lower female terminal 30. Although not shown, the other end of the lower wire W is connected to a device side. The other configuration is the same as the upper female terminal 30. Two female bodies 31 are disposed coaxially with respect to an inserting direction of the male terminal 11. Since two female terminals 30 are disposed one above the other in one first cavity 21 as described above, the female connector housing 20 can be reduced in size as compared to a conventional configuration in which cavities are respectively provided at positions corresponding to two male terminals.

Next, functions of this embodiment are described.

The male plug 10 is held by inserting an index finger into the grip body portion 13 of the male plug 10, and the male terminal 11 of the male plug 10 is inserted into the first cavity 21 of the female connector housing 20. At this time, although not shown, a guide for guiding the male terminal 11 into the female body portions 31 is provided between an insertion opening of the first cavity 21 and an upper end part of the upper female body 31. The male terminal 11 contacts the guide to be guided into the upper female body 31. The wire connecting portions 35 of the female terminals 30 extend in a direction intersecting the inserting direction of the male terminal 11. Thus, the wires W connected to the wire connecting portions 35 and the male terminal 11 do not contact each other by the insertion of the male terminal 11.

When being inserted into the upper female body 31, the male terminal 11 resiliently contacts the contact portions 34 of the resilient contact pieces 33 inside the female body 31. Thus, the male terminal 11 slides against the contact portions 34 of the resilient contact pieces 33 during the insertion thereof.

When being inserted farther into the first cavity 21, the male terminal 11 is inserted into the lower female body 31. At this time, as with the case of the upper female body 31, the male terminal 11 is inserted into the lower female body 31 while sliding against the contact portions 34 of the resilient contact pieces 33 of the lower female body 31. Further, the rubber ring 15 mounted on the grip base end part 14 of the male plug 10 also is inserted into the first cavity 21. The outer diameter of the rubber ring 15 is somewhat larger than the inner diameter of the first cavity 21, as described above. Thus, the rubber plug 15 prevents water from penetrating into the first cavity 21.

When the male terminal 11 is inserted to an inner back side of the first cavity 21, the insertion of the male terminal 11 is stopped by the contact of the male terminal 11 with a front stop wall provided inside the first cavity 21, although not shown. In this state, the male terminal 11 and the two female terminals 30 are electrically conductive. In this way, power is supplied to a device connected to the lower wire W from the high-voltage power supply connected to the upper wire W.

In shutting off a high-voltage power supply circuit, the male plug 10 is pulled out from the first cavity 21 by inserting, for example, an index finger into the grip body 13 of the male plug 10 and holding and pulling up the male plug 10 so that the high-voltage power supply circuit is shut off.

In a conventional service plug, it has been necessary to provide as many male terminals as female terminals in a male plug and, further, a metal conductor linking the male terminals. However, in the above configuration, the female terminals 30 in the female connector housing 20 simultaneously are connected electrically by one male terminal 11 provided in the male plug 10. This eliminates the need for the conventionally required metal conductor linking the male terminals and requires only one male terminal 11. Thus, the male plug 10 can be reduced in size. Further, in the conventional service plug, it has been necessary to provide as many cavities as female bodies in a female connector housing. However, in the above configuration, the female bodies 31 are disposed coaxially with respect to the inserting direction of the male terminal 11 in the female connector housing 20. Thus, one cavity in the female connector housing 20 can be used in common so that the female connector housing 20 and the entire service plug 1 can be reduced in size. Further, as the service plug 1 is reduced in size, the cost of the service plug 1 can be reduced.

The metal conductor linking the male terminals and required in the conventional male plug is unnecessary and the number of the male terminals conventionally required to be as many as the female terminals is reduced to one. Thus, the used amount of the conductor of the male plug 10 is reduced. In this way, the resistance of the conductor of the male plug 10 can be reduced.

The metal conductor required in the conventional male plug is unnecessary as described above. Thus, the male plug 10 can be reduced in size. Further, a hand-grippable grip portion conventionally has been necessary. However, since only one male terminal 11 is used according to the above configuration, the grip 12 of the male plug 10 can be formed into such a circular annular shape that an index finger can be inserted therein to reduce the size of the male plug 10.

Further, the above configuration ensures that the wires W are not disposed on an insertion path for the male terminal 11, and the damage of the wires W by the male terminal 11 can be prevented.

The invention is not limited to the above described and illustrated embodiment. For example, the following various modes are also included.

Although the male terminal 11 of the male plug 10 is in the form of a bar long in the vertical direction in the above embodiment, the male terminal 11 may have another shape. For example, the male terminal 11 may be in the form of a plate.

Although the male terminal 11 of the male plug 10 is fixed by being press-fit into the grip base end part 14 in the above embodiment, another fixing method can be used. For example, the upper end part of the male terminal 11 may be threaded externally, a screw hole may be provided in the lower end surface of the grip base end part 14, and the male terminal 11 and the grip base end part 14 may be fixed by screwing.

Although two female terminals 30 are disposed in the first cavity 21 in the above embodiment, three or more female terminals 30 may be disposed.

### LIST OF REFERENCE SIGNS

1 . . . service plug
10 . . . male plug
11 . . . male terminal
12 . . . grip
20 . . . female connector housing
30 . . . female terminal
31 . . . female body
35 . . . wire connecting portion

1. A service plug, comprising:
a female connector housing including female terminals; and
a male plug detachably mountable into the female connector housing along an insertion direction, the male plug including a male terminal that is long in the insertion direction;
a high-voltage power supply circuit being shut off by pulling out the male plug from the female connector housing;
wherein:
each of the female terminals includes a box-shaped or tubular female body having an opening, the male terminal being insertable into the opening, an L-shaped coupling extending from an end part on an opening side of one side wall of the female body and being aligned in one direction intersecting the inserting direction of the male terminal, and a plate-like wire connecting portion extending in the one direction from an end part of the coupling portion;
a plurality of the female bodies being inside the female connector housing and being arranged coaxially with respect to the inserting direction of the male terminal; and
one male terminal is inserted into the plurality of female bodies and bodies, so that the female terminals and the one male terminal are electrically connected by mounting the male plug into the female connector housing.

2. The service plug of claim 1, wherein the male plug includes a circular annular grip provided on an end part of the male terminal.

3. (canceled)

4. A service plug, comprising:
a female connector having a housing with two female terminals formed from an electrically conductive material, each of the female terminals including a box-shaped or tubular female body having an opening, the female bodies being aligned coaxially with respect to one another along an insertion direction, each of the female terminals including a coupling extending in one direction intersecting the inserting direction, and the couplings being connected respectively to conductive cores of wires; and
a male plug detachably mountable to the female connector housing along the insertion direction, the male plug including one electrically conductive male terminal that is long in the insertion direction, the one male terminal being inserted into the coaxially aligned female bodies as the male plug is mounted to the female connector housing so that the female terminals and the one male terminal are connected electrically.

5. The service plug of claim 4, wherein the male plug includes a grip formed from a non-conductive material provided on an end part of the male terminal that is spaced from the female terminals and projecting from the female connector housing when the male plug is mounted to the female connector housing.
